(19) United States
(12) Patent Application Publication
(10) Pub. No.: US 2015/0039502 A1
(43) Pub. Date: Feb. 5, 2015

(54) MISAPPROPRIATION PROTECTION BASED ON SHIPPING ADDRESS OR STORE INFO FROM E-RECEIPT

(71) Applicant: BANK OF AMERICA CORPORATION, Charlotte, NC (US)

(72) Inventors: Jason P. Blackhurst, Charlotte, NC (US); Matthew A. Calman, Charlotte, NC (US); Laura C. Bondesen, Charlotte, NC (US); Katherine Dintenfass, Charlotte, NC (US); Carrie A. Hanson, Charlotte, NC (US)

(73) Assignee: BANK OF AMERICA CORPORATION, Charlotte, NC (US)

(21) Appl. No.: 13/958,786

(22) Filed: Aug. 5, 2013

(51) Int. Cl. G06Q 20/12; G06Q 10/08

(52) U.S. Cl. CPC G06Q 20/12; G06Q 10/0838
USPC 705/42

(57) ABSTRACT

Embodiments of the invention are directed to a system, method, or computer program product for utilizing e-receipt data and other electronic communication data between a merchant and customer regarding a transaction to provide misappropriation protection based on address and/or merchant store information associated with the e-receipt or other e-communication. In one embodiment, a system is configured to: identify and retrieve electronic communications between a merchant and a customer associated with a transaction; determine address information or merchant store information from the electronic communication; and determine whether or not the address information or merchant store information triggers a notification or an alert to the customer based at least partially on one or more rules relating to a misappropriation of customer account information.

### BACKGROUND

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase. The order confirmation includes detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. For most online transactions, the merchant will send at least one second communication confirming shipment of the order. The order shipment confirmation is typically also sent via email to the customer and typically includes the same information as the order confirmation, and in addition, shipping date, tracking number, and other relevant information regarding the order and shipment parameters.

Many merchants now also provide e-receipts to customers shopping at brick and mortar locations. In general, at the point of sale, the customer may have previously configured or may be asked at the time of sale as to whether she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

### BRIEF SUMMARY

For the most part, order confirmations, shipping confirmations, e-receipts, and other electronic communications between merchants and customers are used only by the customer as proof of purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction data, but also to manage finances. A current drawback with online banking is that transactional level detail for a given purchase by the customer is limited. Despite the large amount of information sent by merchants to customers regarding purchases, merchants currently do not provide purchase details to financial institutions. The only information provided to the financial institution is information about the merchant and an overall transaction amount. For example, if a financial institution customer purchases several clothing items from a merchant and uses a financial institution debit card, credit card or check, all that is provided to the financial institution is the merchant information and overall purchase. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budget tools. In general, budget tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate if the customer is not using the receipt in making such allocations.

Customer cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data to obtain an understanding of the details of a given purchase transaction.

In light of the above, the current invention contemplates use of e-receipt data and other electronic communication data between a merchant and customer regarding a transaction in order to augment purchase transaction data in online banking. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

In some embodiments, the invention may initially search and located electronic communications associated with a transaction made by a customer. Once these electronic communications are located, the invention may extract the data. This may be done by extracting the communications from a customer email account or the like. As such, the system may parse out one or more communications that have purchase transaction data associated therewith. This data may include e-receipt data, order confirmation data, product specific data, shipping confirmation data, or the like. Thus the invention may retrieve identified electronic communications associated with a transaction.

In some embodiments, the invention, after parsing out the purchase transaction data associated with customer transactions, may aggregate this data and convert it from the unstructured form it is in when communicated between the merchant and the customer to a structured form. The data when communicated between the merchant and the customer is in an unstructured form. In this way, each communication from various merchants is different. For example, one merchant may email an e-receipt with the price, SKU data, product information, or the like in one location while another merchant's e-receipt may be totally different in set up and in the format in which it was sent. As such, the invention takes the unstructured data from all of the various merchant communications and converts it to a structured data form.

Next, the invention matches the purchase transaction data, now in a structured form, to the customer's online banking. As detailed above, a customer's online banking environment may only have an overall dollar amount, the merchant name, and date of the purchase transaction for any given transaction. As such, the addition of purchase transaction data parsed from the e-receipts allows the invention to present all of the purchase transaction data to the customer via his/her online banking environment. In this way, for any given transaction the customer may be able to see the exact products he/she purchased, the price of each product, and the like while viewing his/her online banking application. As such, the customer may not need to keep receipts or other papers associated with the transaction, because that data is not integrated into the customer's online banking application.

Furthermore, not only may the customer view purchase transaction level data the invention may build a personal finance management interface that is based both on the transaction data known by the financial institution and the purchase transaction data from the electronic communication. This allows the creation of a granular categorization of customer item level spending. Furthermore, the personal finance management interface may also be able to identify and incorporate cash transactions into the interface, which prior to this invention was impossible for an online banking application to do so.

Embodiments of the invention relate to systems, methods, and computer program products for providing misappropriation protection based on address information or store information obtained from an electronic communication between a customer and a merchant regarding a transaction, the invention comprising: identifying an electronic communication between a customer and a merchant, wherein the electronic communication is associated with a transaction between the customer and the merchant; extracting purchase transaction data from the electronic communication between the customer and the merchant, wherein the purchase transaction data is product level data about products of the transaction between the customer and the merchant; converting the purchase transaction data to be compatible with an online banking application; matching the purchase transaction data to transaction data on the customer's online banking application; integrating the purchase transaction data with data on the customer's online banking application; determining address information or merchant store information from the electronic communication; and determining whether or not the address information or merchant store information triggers a notification or an alert to the customer based at least partially on one or more rules relating to a misappropriation of customer account/transaction information.

In some embodiments, the address information is a shipping address or wherein the merchant store information is a store number associated with a location of the merchant.

In some embodiments, the invention is configured to compare portions of the address information or portions of the store information to the one or more rules relating to the misappropriation of customer account information.

In some embodiments, the invention is configured to flag a purchase transaction associated with the electronic communication by providing, via an online banking account, an indicator of potential misappropriation proximate to information associated with the purchase transaction based at least partially on determining that one or more of the one or more rules relating to misappropriation of customer account information is satisfied.

In some embodiments, the invention is configured to provide a notification to the customer based at least partially on determining that one or more of the one or more rules relating to misappropriation of customer account information are satisfied.

In some embodiments, the one or more rules relating to misappropriation of customer information include a rule for comparing a listed or known customer address to a delivery address determined from the electronic communication, a rule for comparing one or more addresses previously used by a customer for receiving purchase transaction deliveries to a delivery address determined from the electronic communication, a rule for determining that a delivery address determined from the electronic communication is to a country other than a country associated with a customer associated with the electronic communication, a rule for determining that a delivery address determined from the electronic communication is to a state other than a state associated with a customer associated with the electronic communication, a rule for determining that a delivery address determined from the electronic communication is to an area associated with statistically determined high levels of misappropriation, and a rule for determining that a delivery location determined from the electronic communication is to a non-registered device and/or a device not associated with a customer associated with the electronic communication.

### BRIEF DESCRIPTION OF THE DRAWINGS

Having thus described embodiments of the invention in general terms, reference will now be made to the accompanying drawings, wherein:

FIG. 1 provides a high level process flow illustrating the integration of purchase transaction level data from e-receipts into an online banking application process, in accordance with one embodiment of the present invention;

FIG. 2 provides a purchase transaction level data integration system environment, in accordance with one embodiment of the present invention;

FIG. 3 provides a process map illustrating converting the electronic communication to usable purchase transaction level data, in accordance with one embodiment of the present invention;

FIG. 4 provides a process map illustrating the integration of purchase transaction level data from e-receipts into an online banking application, in accordance with one embodiment of the present invention;

FIG. 5 provides a process flow illustrating providing misappropriation protection based on address or store information associated with an electronic communication, in accordance with one embodiment of the present invention;

FIG. 6 provides a process map illustrating various electronic communications between a customer and merchant, in accordance with one embodiment of the present invention;

FIG. 7 provides a decision map illustrating the customer's implementation of integration of purchase transaction level data from e-receipts into an online banking application process, in accordance with one embodiment of the present invention;

FIG. 8 provides an illustration of an interface of an electronic communication between a merchant and a customer providing purchase transaction data to the customer, in accordance with one embodiment of the present invention; and

FIG. 9 provides an illustration of an interface of an online banking application with the electronic communications associated therewith, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

The term “purchase transaction data” as used herein may include any data about the transaction identified in a communication between a merchant and a customer. This data may include the same or similar data as to what is on an e-receipt.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

Some portions of this disclosure are written in terms of a financial institution's unique position with respect to customer transactions. As such, a financial institution may be able to utilize its unique position to create and update online banking applications associated with customers of the financial institution.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

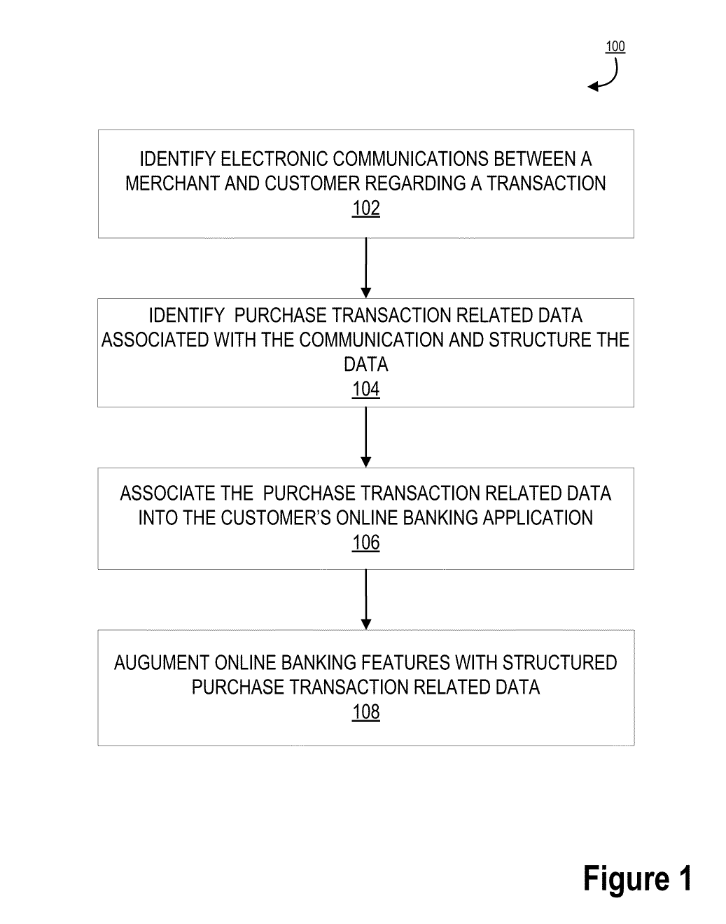

FIG. 1 illustrates a general process flow for providing misappropriation protection based on purchase level data related to a shipping address or business merchant from an e-receipt, in accordance with one embodiment of the present invention. As represented by block 102, a system identifies electronic communications between a merchant and a customer where the communications are regarding a transaction. In this way, the system may monitor a customer's email account, social network account, or the like to identify communications from a merchant that are associated with a recent customer transaction.

As represented next by block 104, the system executing process flow 100 continues to identify purchase transaction related data associated with the communication between a merchant and a customer. Once the purchase transaction related data is identified, the data being an unstructured form may be converted into a structured form. As such, data coming from several different servers or different merchants in an unstructured form may be processed into a structured form in block 104.

Next, as illustrated in block 106, the process 100 continues by associating the purchase transaction related data into the customer's online banking application. In this way, the system may integrate the purchase transaction level data, such as the price of each product, the product type, product brand, SKU data, and the like into the customer's online banking application. Furthermore, transactions made with other payment means such as cash or credit cards associated with entities other than the financial institution providing the online banking application may also be identified. In this way, the customer's online banking may have more product specific data about a transaction. For example, a typical online banking application may identify a transaction for $XX.XX dollars at Merchant A. However, associating the purchase transaction data for that transaction may now allow an online banking application to present to the customer more data about the transaction. For example, the online banking application may now state Product 1 $X.XX, Product 2 $X.XX. Product 3 $XX.XX for a total of $XX.XX. Thus providing more detail for the products purchased during the transaction. Furthermore, the e-receipt associated with the transaction may also be presented via the customer's online banking application.

As illustrated in block 108, the features of the online banking application may be augmented with the structured purchase transaction data. As such, features such as budgeting applications, or the like may be augmented with the purchase transaction level data to provide a more accurate categorization of expenses or the like.

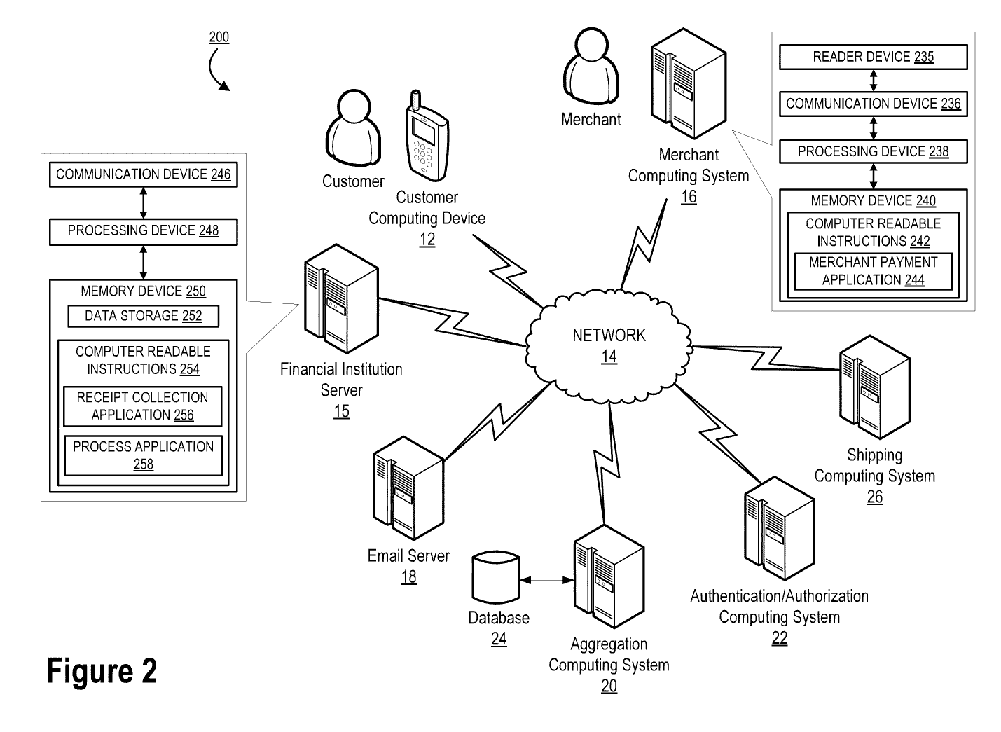

FIG. 2 provides a purchase transaction level data integration system environment 200, in accordance with one embodiment of the present invention. The system environment 200 provides for retrieval of electronic communications relating to customer purchase transactions, parsing of data within such electronic communications into structured data, and inclusion of such data into online banking. As illustrated in FIG. 2, the financial institution server 15 is operatively coupled, via a network 14 to the customer computing device 12, merchant computing system 16, shipping computing system 26, authentication/authorization computing system 22, aggregation computing system 20, and the email server 18. In this way, the financial institution server 15 can send information to and receive information from the customer computing device 12, merchant computing system 16, shipping computing system 26, authentication/authorization computing system 22, aggregation computing system 20, and the email server 18. FIG. 2 illustrates only one example of an embodiment of a purchase transaction level data integration system environment 200, and it will be appreciated that in other embodiments one or more of the systems, devices, or servers may be combined into a single system, device, or server, or be made up of multiple systems, devices, or servers.

The network 14 may be a global area network (GAN), such as the Internet, a wide area network (WAN), a local area network (LAN), or any other type of network or combination of networks. The network 14 may provide for wireline, wireless, or a combination wireline and wireless communication between devices on the network 14.

In some embodiments, the customer is an individual making a transaction with a merchant. The transaction may be made at a merchant computing system 16, online or offline, over the phone, at the merchant's place of business and/or other transaction means. The purchase may be made by the customer using a customer computing device 12 such as a mobile wallet (i.e. smart phone, PDA, and the like) or other types of payment systems that communicate with the merchant computing system 16 and/or financial institution server 15 to allow the customer to enter into a transaction and/or receive communications associated with the transaction In some embodiments, the customer may be a merchant or a person, employee, agent, independent contractor, and the like acting on behalf of the merchant to enter into a transaction.

As illustrated a customer maintains one or more computing devices 12, such as a PC, laptop, mobile phone, tablet, television, or the like that is network enabled for communicating across a network 14.

Also, in the system environment 200 is one or more merchant computing systems 16 that is network enabled. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store (or brick and mortar) purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

As such, the merchant computing system 16 generally comprises a reading device 235, a communication device 236, a processing device 238, and a memory device 240. The reading device 235 is operatively coupled to the processing device 238, communication device 236, and the memory device 240. The merchant computing system 16 may include a reader device 235 to receive payment vehicle information from the customer such as online and/or offline purchases. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the customer's payment vehicle and/or transaction data at the merchant computing system 16 and communicates the information via the communication device 236.

As further illustrated in FIG. 2, the merchant computing system 16 comprises computer-readable instructions 242 stored in the memory device 240, which in one embodiment includes the computer-readable instructions 242 of a merchant payment application 244.

In general, the merchant computing system 16 will provide the customer with information relating to the purchase transaction. In the context of an online purchase, the communications may take the form of purchase order confirmations provided as a web page or as an email or as both. In some, embodiments, the merchant computing system 16 may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data, as well as other parameters associated with the product, such as type/category, size, color, and the like, as well purchase price information, information associated with the merchant, and the like. The merchant computing system 16 may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system 16 may send an e-receipt comprising information similar to that of the purchase order confirmation. In some instances, the customer may actually receive a paper receipt, which the customer may choose to scan into an electronic form and save in a storage device associated with the customer computing device 12.

As such, in the embodiment illustrated in FIG. 2, the merchant payment application 244 allows the merchant computing system 16 to be linked to the financial institution server 208 and the merchant computing system 16 to communicate, via a network 201, the information related to the transaction being made such as communicating an e-receipt associated with the transaction. Furthermore, the merchant payment application 244 may be able to receive communications from the financial institution server 208 such as requests for receipts or the like.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 12, or in an email server 18, or in a customer's account at the merchant's computing system 16. Furthermore, as mentioned, the purchase transaction related information is in an unstructured format. Each merchant may use a customized reporting format for the communications, whereby various data relating to the purchase transaction may be placed in different sequences, different locations, different formats, or the like for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the system environment 200 further comprises an aggregation computing system 20. The aggregation computing system is operatively connected to at least one of the customer computing device 12, the merchant computing system 16, the financial institution server 15, and the email server 18 via the network 14. The aggregation computing system 20 is configured to initially search and locate electronic communications associated with purchase transactions made by the customer, in for example, the customer's email, computer storage device, online accounts, and the like. For this purpose, the system may optionally include an authentication/authorization computing system 22 that comprises security IDs and passwords and other security information associated with the customer for accessing customer's email, storage devices, and customer online accounts.

Regarding email extraction, aggregation computing system 20 initially gains access to the customer's email accounts and retrieves email message headers comprising data fields relative to the email message, such as sender, subject, date/time sent, recipient, and the like. In some embodiments, the aggregation computing system 20 accesses the emails directly. In other embodiments, the aggregation computing system 20 may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 20. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: (i) a text order confirmation template; (ii) an HTML order confirmation template; (iii) a text shipping confirmation template; and (iv) an HTML shipping confirmation template. Where the email is an e-receipt from a brick and mortar purchase, another template may be used that is specific to the merchant. For some online merchants there are greater or fewer templates depending upon what are the various forms of email messages or a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts, typed or handwritten notes, invoices, bills of sale, and the like in a storage device or print and save purchase order and shipping confirmation communications sent to the customer by the merchant via a web page. In this instance, the aggregation computing system 20 may first perform optical character recognition “OCR” on the scanned or printed receipts prior to performing the processing performed above. Further, a customer may maintain an online account with a merchant containing purchase data information. In this instance, the aggregation computing system 20 will access the data online via communication with merchant computing system to retrieve this data. The aggregation computing system 20 may use column and/or row headers associated with the online data to parse the data, or it may use procedures similar to the above and discussed below to parse the data into appropriate fields.

Returning to data processing procedures within the system environment 200, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, or the like to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system may use these tags to identify the shipping and/or tracking information for extraction.

Once relevant information is extracted from communications between the customer and merchant regarding purchase transactions, it is stored in purchase data records in a structured database 24.

As is understood, once the purchase transaction data has been extracted, various information regarding a particular purchase transaction is now known, such as merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping company computer system 26, product images, information about product returns, warranty information, recall information, and the like. In particular, the aggregation computing system may (1) communicate with the merchant and/or shipping company to update the shipping and delivery information extracted and stored in the database, (2) may search the merchant or the web in general to retrieve product images, and/or (3) communicate with merchant for return policies, warranties, insurance, recalls, and the like.

A portion of the above describes an aggregation computing system according to one embodiment of the present invention. An example of an aggregation computing system is described in U.S. Published Patent Application No. 2013/0024525 titled Augmented Aggregation of Emailed Product Order and Shipping Information, the contents of which are incorporated herein by reference.

As further illustrated in FIG. 2, the financial institution server 15 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 14 and other devices on the network 14, such as, but not limited to the customer computing device 12, merchant computing system 16, shipping computing system 26, authentication/authorization computing system 22, aggregation computing system 20, and the email server 18. As such, the communication device 246 generally comprises a modem, server, or other device for communicating with other devices on the network 15.

As further illustrated in FIG. 2, the financial institution server 15 comprises computer-readable instructions 254 stored in the memory device 250, which in one embodiment includes the computer-readable instructions 254 of a process application 258. In some embodiments, the computer-readable instructions 254 include a receipt collection application 256. In some embodiments, the memory device 250 includes data storage 252 for storing data related to the integration of transaction level data within online banking, including but not limited to data created and/or used by the process application 258 and/or the receipt collection application 256. In this way, the financial institution server 15 may maintain, updated, and the like the customers' online banking application.

In the embodiment illustrated in FIG. 2 the financial institution server 15 comprises a receipt collection application 256. The receipt collection application 256 allows for collection and storage of purchase transaction level data from electronic communications between a customer and merchant. This data may be sent to the financial institution server 15 by one or more other devices on the network 14, such as, but not limited to the customer computing device 12, merchant computing system 16, shipping computing system 26, authentication/authorization computing system 22, aggregation computing system 20, and the email server 18. As such, the receipt collection application 256 may receive receipt information from the other systems on the network through the communication device 246 to store the receipt, post-transaction.

In some embodiments, the receipt collection application 256 may collect receipts associated with any transaction that includes a customer. The e-receipt collection application 256 may periodically receive receipts associated with the transaction. In other embodiments, the receipt collection application 256 may also request receipts associated with customer transactions. The e-receipts may be collected from the email server 18 or the like.

In some embodiments, the system may receive the receipt from the merchant. In this way, the merchant computing system 16 may automatically send e-receipts to the financial institution server 15. As such, once a transaction has been completed between a customer 202 and a merchant associated with merchant computing system 16, the merchant computing system 16 may automatically, via the network 201, provide the receipt collection application 256 with a receipt associated with that particular transaction. In some embodiments, the system may automatically receive the receipt from the customer and/or access customer accounts to get the electronic communication data from the customer. In some embodiments, the receipt collection application 256 may automatically pull electronic communications for the customer via the email server 18. In other embodiments, the email server 18 may automatically provide the receipt collection application 256 with the electronic communications. In some embodiments, the receipt collection application 256 may receive the data from one or more of the other devices on the network 14.

In the embodiment illustrated in FIG. 2 and described throughout much of this specification, the process application 258 may integrate the purchase transaction data received from e-receipts into a customer's online banking environment.

In some embodiments, the process application 258 may integrate the purchase transaction data into the customer's online banking. In other embodiments, the process application 258 may create one or more unique finance management interfaces based on the purchase transaction data in combination with the data pre-existing on the customer's online banking application. Integration into the customer's online banking application allows for the customer to visualize at a granular level the products purchased during a transaction. For example, a typical online banking application may show a transaction using Credit Card 1 for a total of $XXX.XX from Merchant 2. There is more product level information provided to the process application 258. As such, utilizing this data for budgeting applications, reconciliation, or the like may prove to be inaccurate. As such, the process application 258 incorporates the purchase transaction data identified from an electronic communication between a customer and a merchant. Utilizing the purchase transaction data, the process application 258 may present the customer via his/her online banking application information about the transaction such as a transaction using Credit Card 1 for a total of $XXX.XX from Merchant 2 for Product 1 at $XX.XX Product 2 at $X.XX, Product 3 at $XX.XX Product 4 at $XX.XX and Product 5 at $X.XX. In this way, the process application 258 may be able not only to identify each transaction and the total amount of the transaction, but instead provide product level data for each transaction. In this way, budgeting and/or reconciliation may be more accurately accomplished by the customer.

Furthermore, the process application 258 may provide a link to a copy of the e-receipt directly accessible from the online banking application. This way the customer may be able to visualize the exact communication he/she had with the merchant all while in his/her online banking application.

In some embodiments, the process application 258 may create one or more unique finance management interfaces based on the purchase transaction data in combination with the data pre-existing on the customer's online banking application. In this way the combination of purchase transaction data with the data on the customer's online banking application allow a more granular categorization of purchases based on item level spending as well as an insight into cash transaction data that prior interfaces that do not have access to that data.

It is understood that the servers, systems, and devices described herein illustrate one embodiment of the invention. It is further understood that one or more of the servers, systems, and devices can be combined in other embodiments and still function in the same or similar way as the embodiments described herein.

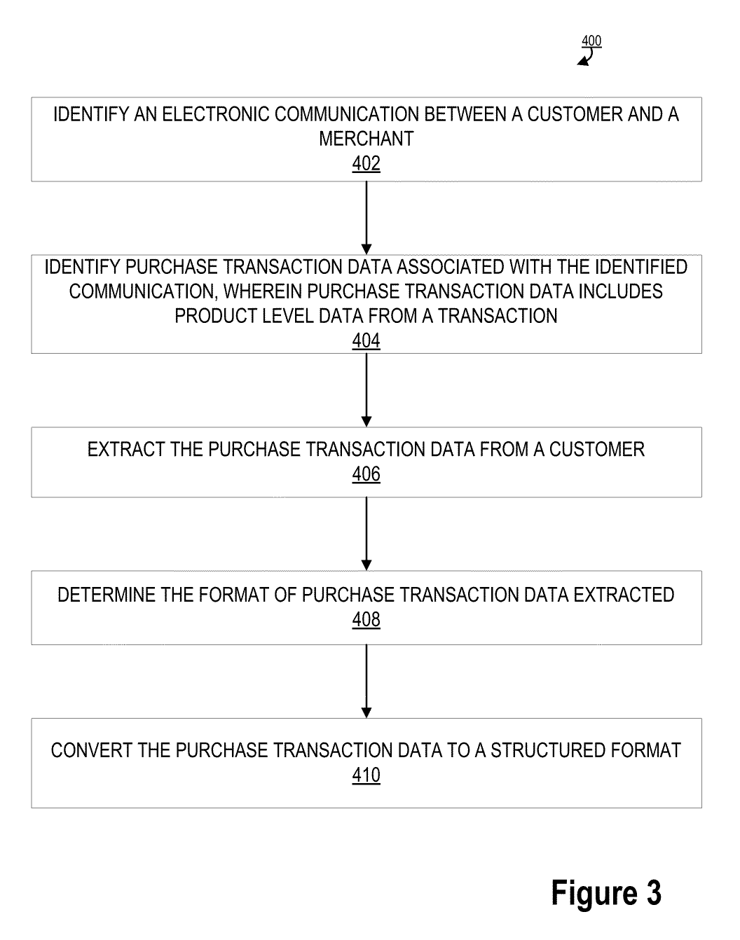

FIG. 3 illustrates a process map for converting the electronic communication to usable purchase transaction level data 400, in accordance with one embodiment of the present invention. As illustrated in block 402, the process 400 is initiated by identifying one or more electronic communications between a customer and a merchant. The electronic communications identified are e-receipts or the like associated with a transaction between the customer and the merchant. In some embodiments, in order to identify the electronic communications the system may have access to the customer's email account or other account in which the communication is sent. In this way, the system may continue to monitor the customer's accounts in order to identify electronic communications between a merchant and customer related to a transaction. Next, as illustrated in block 404, the system may identify purchase transaction data associated with the identified communication. This purchase transaction data includes product purchase level data from a transaction between the merchant and customer.

As illustrated in block 406, the system may extract the purchase transaction data identified. This extraction may be from a customer account, such as an email account or the like. In other embodiments, the extraction may be from a text, voice, or the like message communicated to the customer.

Regarding email extraction, the system may initially gains access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Next, as illustrated in block 408, the process 400 continues to determine the format of the purchase transaction data extracted. As such, the unstructured format from the merchant may be identified such that it may be changed to a structured format to integrate into the online banking application. Finally, as illustrated in block 410 the system may convert the purchase transaction data to a structured format for the online banking application to utilize the purchase transaction data extracted.

Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

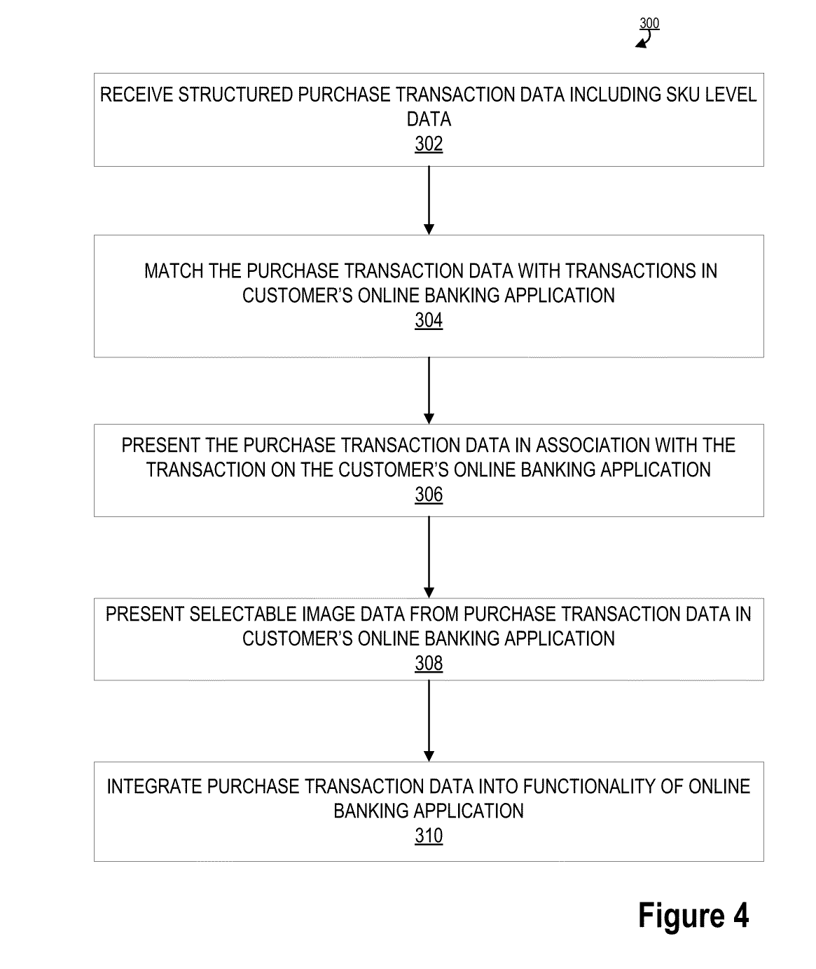

FIG. 4 illustrates a process map for the integration of purchase transaction level data from e-receipts into an online banking application 300, in accordance with one embodiment of the present invention. As illustrated in block 302, the process 300 is indicated by receiving the structured purchase transaction data which includes SKU level data and other product specific data, such as individual price of products, particular products, or the like.

Next, as illustrated in block 304, the system may match the purchase transaction data with transactions in the customer's online banking application. In this way, a financial institution may have some information about a transaction which occurred utilizing one or more of the financial institution products. As such, if the customer utilized a financial institution product, the customer may visualize the purchase on his/her online banking application. Furthermore, the financial institution may identify purchase transaction data received from merchant/customer communications that match the same date, total purchase price, or merchant transaction data at the financial institution. The transaction data at the financial institution may be the total purchase price of the transaction, or other data that may be presented to a customer via an online banking application.

Once matched, the system may present the purchase transaction data in association with the transaction on the customer's online banking application, as illustrated in block 306. In this way, the system may allow a customer to vie the purchase transaction level data via his/her online banking application. As such, the customer may be able to view item level spending at his/her online banking application. Thus, the customer may be able to reconcile his/her transactions and/or budget with accuracy. In this way, the system, as illustrated in block 308, may present selectable image data from the purchase transaction data in the customer's online banking application. In this way, the customer may be able to select and visualize e-receipts from his/her online banking application. As such, the customer may be able to select a transaction on his/her online banking application (where the transaction indicates the merchant and the total purchase price) and allow the customer to visualize image data from the purchase transaction. This image data may be an e-receipt or the like that illustrates the products of the transaction, SKU data, purchase price of each product of the transaction, order information, or the like.

Finally, as illustrated in block 310, the system allows for integration of the purchase transaction data into the functionality of the online banking application. In this way, the customer may be able to visualize the purchase transaction data for all transactions into his/her budgeting, expenses, or the like. As such, even cash transactions may be identified based on purchase transaction data and implemented into the functionality of the online banking application. As such, all transactions that have e-receipts or electronic communications associated with the transaction, irrespective of the payment product used by the customer, may be visualized via the customer's online banking application. In this way, not only are transaction totals for transactions utilizing the financial institution products incorporated into the online banking application, all other customer transactions (irrespective of payment product utilized) may be incorporated into the online banking application and integrated into the functionality of the online banking application.

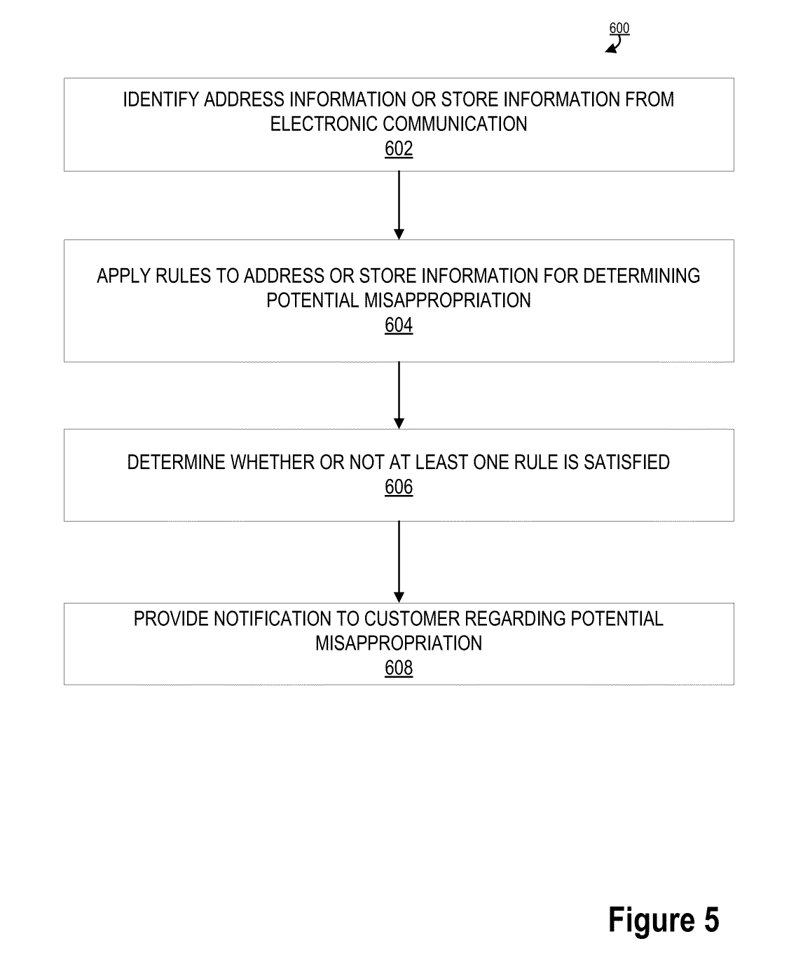

FIG. 5 illustrates a process flow for providing misappropriation protection based on address or store information from an electronic communication between a merchant and a customer, in accordance with some embodiments of the present invention. As illustrated in block 602, the system identifies address information or merchant store information from the electronic communication between a merchant and a customer relating to a purchase transaction. The address information may include an address and/or location to which a subject of the purchase transaction will be delivered or is shipping from and/or delivered from. The merchant store information may include a store number and/or some other merchant store identifier. In some embodiments, the subject of the purchase transaction is a good, service, information, and/or a combination thereof. In some embodiments, the address and/or location to which the subject is delivered to is a physical address. As an example, in some embodiments, the electronic communication is an e-receipt containing address information, where the address information includes the physical shipping address of the customer. In some embodiments, the address and/or location to which the subject is delivered is a virtual location. Examples of one or more virtual locations for delivery may include a server (e.g., e-mail server, social network server, or the like) or an electronic storage device configured to store electronic data.

Still regarding block 602, in some embodiments, the address information from the electronic communication may relate to a merchant location and/or a merchant store information. In some embodiments, a purchase transaction involving a customer and a merchant is performed at a physical location of the merchant. In such embodiments, an electronic communication (e.g., ereceipt or the like) from the merchant to the customer results from the transaction, where the electronic communication comprises an address and/or location of the merchant and/or other merchant store information, such as a store number.

Now, at block 604, once the system identifies address information from the electronic communication, the system applies one or more rules to the address information and/or merchant store information for determining a potential of customer transaction information misappropriation. Thus, in some embodiments, the applied one or more rules relate to triggers for detecting a potential of misappropriation affecting a customer, such that when one or more of the rules are satisfied and/or not satisfied by the application of the rules, the system may flag the purchase transaction associated with the electronic communication and/or provide an alert. The application of the rules, in some embodiments, is a comparison of elements of the rules to elements of the address and/or location information determined from the electronic communication. Some examples of the one or more rules include: a) a rule for comparing a listed or known customer address to a delivery address determined from the electronic communication; b) a rule for comparing one or more addresses previously used by a customer for receiving purchase transaction deliveries to a delivery address determined from the electronic communication; c) a rule for determining that a delivery address determined from the electronic communication is to a country other than a country associated with a customer associated with the electronic communication; d) a rule for determining that a delivery address determined from the electronic communication is to a state other than a state associated with a customer associated with the electronic communication; e) a rule for determining that a delivery address determined from the electronic communication is to an area associated with statistically determined high levels of misappropriation; f) a rule for determining that a delivery location determined from the electronic communication is to a non-registered device and/or a device not associated with a customer associated with the electronic communication. It will be understood that the previously-described one or more rules for determining misappropriation are just examples and more and/or different rules for determining misappropriation based on address and/or merchant information may be applied by the system. A rule of the one or more rules for determining misappropriation is satisfied when any one or more of these events is determined by the system: 1) an address and/or location information matches address and/or location information of a rule; 2) an address and/or location information does not match address and/or location information of a rule; 3) a device receiving delivery of a subject of a purchase transaction associated with the electronic communication matches a device associated with a rule; 4) a device receiving delivery of a subject of a purchase transaction associated with the electronic communication does not match a device associated with a rule. It will be understood that the one or more rules may be satisfied and/or not satisfied based on more and/or different criteria other than the example criteria described-above for satisfying the one or more rules for determining misappropriation based on address and/or location information determined from an electronic communication.

As illustrated in block 606, once the system determines whether or not, at least, one of the one or more rules for determining misappropriation is satisfied, the system flags the purchase transaction associated with the electronic communication. The purchase transaction is flagged for several reasons including to indicate to a customer that a purchase transaction associated with one or more of his financial accounts or accounts used for purchasing may have been compromised and/or used for reasons involving misappropriation and/or to indicate that the purchase transaction should be specifically reviewed by a financial institution or customer prior to finalizing the purchase transaction. Finalizing the transaction may include charging an amount or money value associated with the purchase transaction of the electronic communication against a financial account or other account for conducting purchase transactions that are held or otherwise useable by the customer for conducting purchase transaction.

Still regarding block 606, in some embodiments, the system is configured to present, via an online banking account/interface, an indicator that a purchase transaction involving the account associated with the online banking account may be compromised and/or otherwise involves misappropriation. The indicator, in some embodiments, is presented such that the indicator is positioned immediately next to and/or proximate to a posted or posting transaction amount associated with the purchase transaction of the electronic communication. The indicator may be an indicator of potential misappropriation. In some embodiments, the indicator may be any symbol, figure, sequence of numbers and/or letters, image, drawing, and/or the like that a customer would recognize as a signal or alert that a transaction posted or posting to an account potential involves misappropriation. As an example, an indicator in the shape and color of a red flag may be positioned, via an online banking account interface, immediately next to a purchase transaction amount of $XX.XX for indicating that the transaction for $XX.XX should be specifically reviewed by the customer. In some embodiments, the indicator of misappropriation is selectable by a customer, such that when the customer selects the indicator the customer is provided additional information or instructions for reviewing and/or taking meaningful steps for resolving/reconciling the transaction. In such an embodiment, upon selecting the indicator, the customer may be redirected to a new window and/or webpage for resolving the purchase transaction. Similarly, in another embodiment, upon selecting the indicator, a window of information is presented to the user providing information identifying the cause for the indicator, the status of the transaction, information for contacting an agent for resolving the purchase transaction, and/or the like.

As represented by block 608, upon determining that a purchase transaction may involve misappropriation based on an electronic communication, the system provides a notification and/or an alert of potential misappropriation to a customer associated with an account affected by the purchase transaction. The notification and/or alert to the customer may be any kind or type of notification and/or alert. The notification and/or alert of potential misappropriation may be presented via e-mail, via SMS messaging (e.g., text messaging), via an online banking account, via telephone, via telegram, and/or otherwise and known method of electronically communicating with a customer. In some embodiments, the notification and/or alert is provided with the indicator and in some embodiments, is the indicator of misappropriation. In other embodiments, a notification and/or alert of misappropriation is different than the indicator of misappropriation, in that, the notification and/or alert of misappropriation is an active or otherwise dynamic notification/alert/indicator of misappropriation rather than a passive indicator of misappropriation. For instance, a notification of misappropriation may be a flashing and/or moving signal displayed via an online banking account/interface of a customer. In this way, the notification is readily noticeable by a customer viewing information via an online banking account. Similar to the indicator of misappropriation, the notification and/or alert of misappropriation may be selectable by a customer, such that when a customer selects the notification and/or alert he is provided information or directed to information for resolving the notification.

In addition, upon determining that a purchase transaction may involve misappropriation based on an electronic communication, the system is configured to present to a merchant a notification and/or alert of potential misappropriation. The notification to the merchant may include instructions to stop a shipment or delivery of the product that is the subject of the purchase transaction. In this way, a merchant can avoid liability or loss based on shipping a product based on a transaction that potentially involves misappropriation.

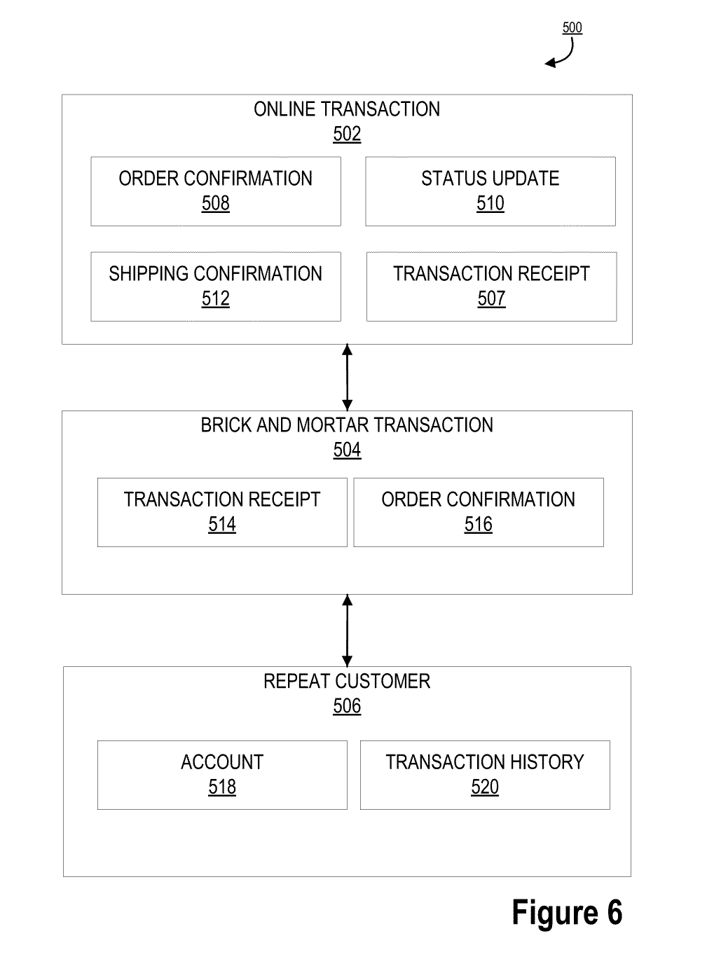

FIG. 6 illustrates a process map for the various electronic communications between a customer and merchant 500, in accordance with one embodiment of the present invention. These potential electronic communications include communications that derived from online transactions 502, brick and mortar transactions 504, or repeat customer 506 transactions.

In some embodiments, online transaction 502 communications may include transaction receipts 507. Other communications for online transactions 502 may include order confirmations 508, status updates 510, shipping updates 512, or the like. The combination of all of these communications may be considered e-receipts, as described above. E-receipts may be any electronic communication from a merchant to a customer based on a transaction. An order confirmation 508 may include detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation 508 also includes information about the merchant, such as name, address, phone number, web address, and the like. The shipment confirmation 512 may be an email, text, voice, or other correspondence from a merchant to a customer indicating the shipment of a product from an online transaction. Status updates 510 may include any type of communication from a merchant that may update the shipping, delivery, order, or stocking of a product of a transaction.

In some embodiments, purchase transaction communications may include communications related to transactions at a brick and mortar location 504. In this way, many merchants now also provide e-receipts and other electronic communications to customers shopping at brick and mortar locations. In some embodiments, these communications may include transaction receipts 514, such as an e-receipt. In other embodiments, these communications may include order confirmations 516. In general, at the point of sale, the customer may have previously configured or may be asked at the time of sale as to whether she wishes to receive an e-receipt. By selecting this option, the merchant will send an electronic communication in the form of an e-receipt to the customer's designated email address.

Here again, the e-receipt will typically include a list of services and/or products purchased with SKU level data, and other parameters, as well as information about the merchant, such as name, address, phone number, store number, web address, and the like.

In some embodiments, purchase transaction communications may include communications from a repeat customer account 506. Various merchants now also provide online customer accounts 518 for repeat customers. These online customer accounts 518 may include purchase history 520 information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

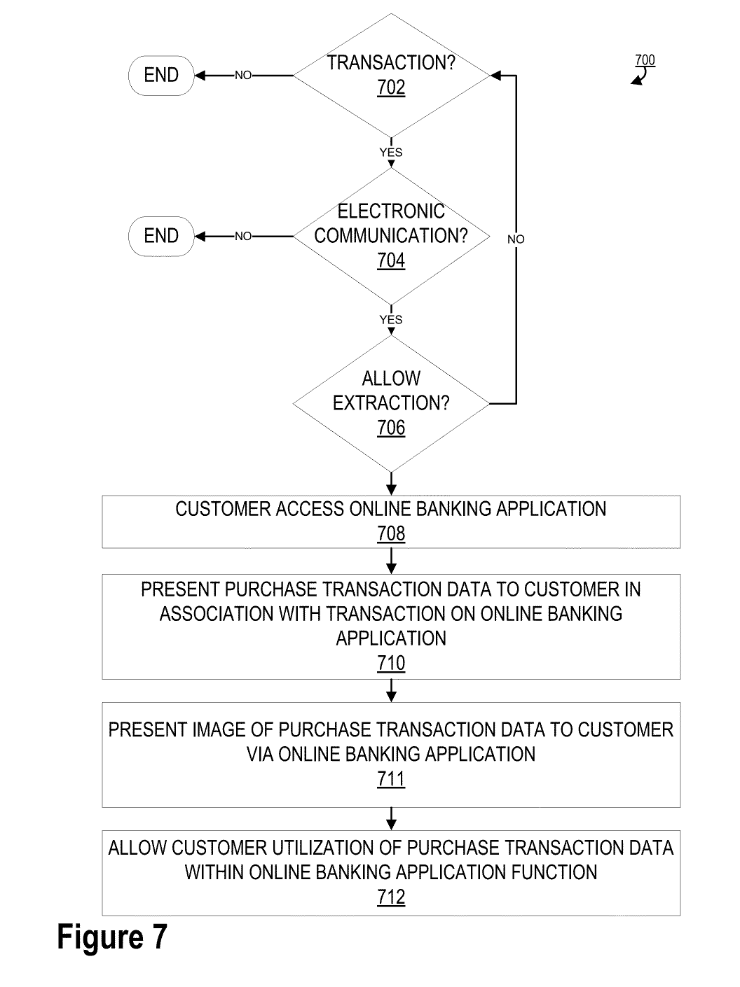

FIG. 7 illustrates a decision map for the customer's implementation of integration of purchase transaction level data from e-receipts into an online banking application process 700, in accordance with one embodiment of the present invention. As illustrated in decision block 702, the customer may enter into a transaction with a merchant. The transaction may be online or off line (at brink and mortar location). If the customer does not enter into a transaction with a merchant the process 700 is terminated. If the customer does enter into a transaction, the process 700 continues at decision block 704. At block 704 the customer may select that an electronic communication may be presented to the customer based on the transaction. In some embodiments, the electronic communication may be automatically sent to the customer if the transaction is online. In some embodiments, the electronic communication may be sent to the customer based on the customer's request, such as a purchase at a brick and mortar merchant location. In some embodiments, the electronic communication may be provided based on a customer account, such as a preferred customer account or the like, that the customer has associated with the merchant.

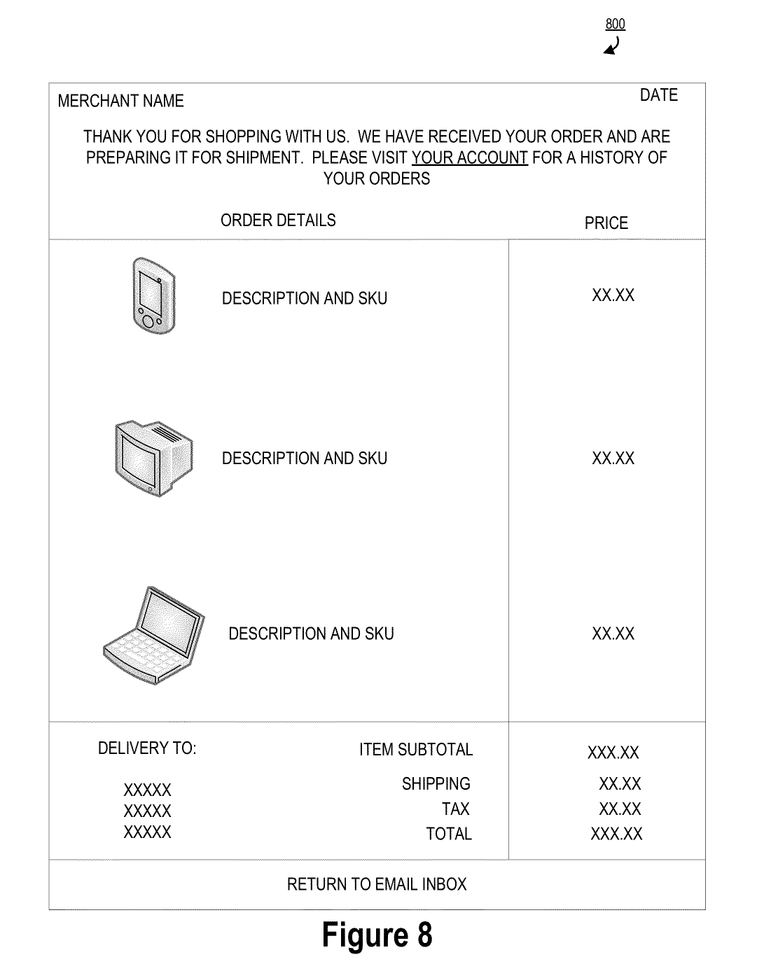

FIG. 8 illustrates an interface of an electronic communication between a merchant and a customer providing purchase transaction data to the customer 800, in accordance with one embodiment of the present invention. As illustrated in FIG. 8, one embodiment of the electronic communication maybe an email from the merchant to the customer. This may be a communication outlining order details. In the example illustrated in FIG. 8, the customer purchased several items, including a cellular phone, telephone, and computer. Each of these items on the communication comprises a description of the item and the SKU number for that item. In this example, the electronic communication is an e-receipt showing the products purchased, the price of each item, the item subtotal, shipping cost, tax cost, and total cost. As such, this illustrates an example of an e-receipt for an online transaction between a customer and a merchant.

Referring back to FIG. 7, if there is no electronic communication in decision block 704, the process 700 is terminated. If there is an electronic communication in decision block 704, the process 700 continues to decision block 706. In decision block 706 the customer may have authorized the system to extract purchase transaction data from electronic communications. In this way, the customer may have provided the system with the account and/or passwords to access and extract electronic communications between a merchant and the customer that are in association with a customer transaction. If no extraction is allowed, then the process 700 reverts back to decision block 702, determining if a transaction has occurred between the customer and a merchant. If the customer has allowed extraction in decision block 706, the process 700 continues to block 708 where the customer may access his/her online banking application. The customer may access his/her online banking application by providing a username and a password or something similar thereto in order to access the application.

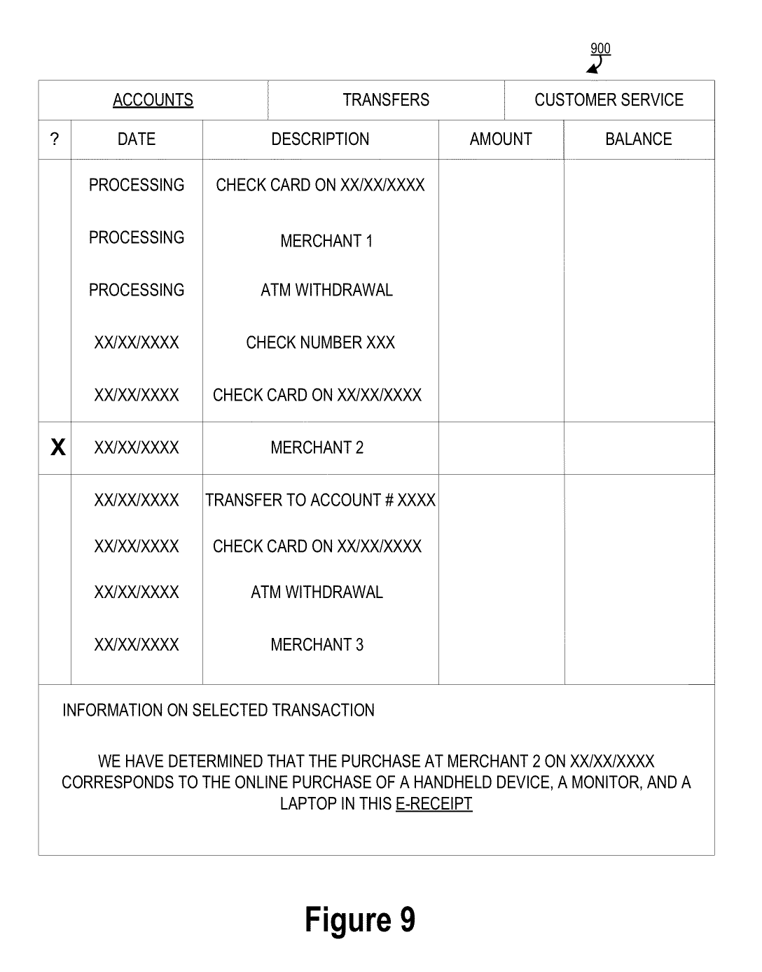

Once the customer accesses his/her online banking application the system may present purchase transaction data to the customer in association with the transaction on the online banking application, as illustrated in block 710. FIG. 9 provides an illustration of an interface of an online banking application with the electronic communications associated therewith 900, in accordance with one embodiment of the present invention. As illustrated in FIG. 9, the customer's online banking application shows several different transactions, including processing transactions from ATM withdrawals, check card transactions, and transactions from Merchant 1. The online banking application identifies a transaction from Merchant 2 as being one that the system has (and has matched) purchase transaction data to the transaction. In this way, the information about the transaction from Merchant 2 is presented such as that is an online purchase of a handheld device (cellular phone), monitor, and laptop. Furthermore, there is a link for the online banking application to access the e-receipt (illustrated in FIG. 8).

The link illustrated in FIG. 9 provides a link to the image of the purchase transaction data (such as the e-receipt illustrated in FIG. 8). Referring back to FIG. 7, the process 700 continues in block 711 by presenting the customer with an image of the purchase transaction data to the customer via the online banking application. This is further illustrated in FIG. 9. Finally, as illustrated in block 712, the system allows the customer to utilize the purchase transaction data within the online banking application functionality.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system for providing misappropriation protection based on address or store information, the system comprising:
a memory device with computer-readable program code stored thereon;
a communication device;
a processing device operatively coupled to the memory device and the communication device, wherein the processing device is configured to execute the computer-readable program code to:
identify an electronic communication between a customer and a merchant, wherein the electronic communication is associated with a transaction between the customer and the merchant;
extract purchase transaction data from the electronic communication between the customer and the merchant, wherein purchase transaction data is product level data about the transaction between the customer and the merchant;
convert the purchase transaction data to be compatible with an online banking application;
integrate the purchase transaction data with data on the online banking application for the customer;
determine address information or merchant store information from the electronic communication; and
determine whether or not the address information or merchant store information triggers a notification or an alert to the customer based at least partially on one or more rules relating to a misappropriation of customer account information.

2. The system of claim 1, wherein the address information is a shipping address or wherein the merchant store information is a store number associated with a location of the merchant.

3. The system of claim 1, wherein the processing device is further configured to:
compare portions of the address information or portions of the store information to the one or more rules relating to the misappropriation of customer account information.

4. The system of claim 1, wherein the processing device is further configured to:
flag a purchase transaction associated with the electronic communication by providing, via an online banking account, an indicator of potential misappropriation proximate to information associated with the purchase transaction based at least partially on determining that one or more of the one or more rules relating to misappropriation of customer account information is satisfied.

5. The system of claim 1, wherein the processing device is further configured to:
provide a notification to the customer based at least partially on determining that one or more of the one or more rules relating to misappropriation of customer account information are satisfied.

6. The system of claim 1, wherein the one or more rules relating to misappropriation of customer information include a rule for comparing a listed or known customer address to a delivery address determined from the electronic communication, a rule for comparing one or more addresses previously used by a customer for receiving purchase transaction deliveries to a delivery address determined from the electronic communication, a rule for determining that a delivery address determined from the electronic communication is to a country other than a country associated with a customer associated with the electronic communication, a rule for determining that a delivery address determined from the electronic communication is to a state other than a state associated with a customer associated with the electronic communication, a rule for determining that a delivery address determined from the electronic communication is to an area associated with statistically determined high levels of misappropriation, and a rule for determining that a delivery location determined from the electronic communication is to a non-registered device and/or a device not associated with a customer associated with the electronic communication.

7. The system of claim 5, wherein one or more of the one or more rules relating to misappropriation of customer account information are satisfied when, at least, one of the following occurs:
a) an address and/or location information matches address and/or location information of a rule;
b) an address and/or location information does not match address and/or location information of a rule;
c) a device receiving delivery of a subject of a purchase transaction associated with the electronic communication matches a device associated with a rule; and
d) a device receiving delivery of a subject of a purchase transaction associated with the electronic communication does not match a device associated with a rule.

8. A computer-implemented method for providing misappropriation protection based on address information or store information, the computer-implemented method comprising:
using a computer processor comprising computer program code instructions stored in a non-transitory computer readable medium, wherein said computer program code instructions are structured to cause said computer processor to:
identify an electronic communication between a customer and a merchant, wherein the electronic communication is associated with a transaction between the customer and the merchant;
extract purchase transaction data from the electronic communication between the customer and the merchant, wherein purchase transaction data is product level data about the transaction between the customer and the merchant;
convert the purchase transaction data to be compatible with an online banking application;
integrate the purchase transaction data with data on the online banking application for the customer;
determine address information or merchant store information from the electronic communication; and
determine whether or not the address information or merchant store information triggers a notification or an alert to the customer based at least partially on one or more rules relating to a misappropriation of customer account information.

9. The computer-implemented method of claim 8, wherein the address information is a shipping address or wherein the merchant store information is a store number associated with a location of the merchant.

10. The computer-implemented method of claim 8, wherein the non-transitory computer-readable medium further comprises executable instructions that when executed by the at least one processing device causes the system to:
compare portions of the address information or portions of the store information to the one or more rules relating to the misappropriation of customer account information.

11. The computer-implemented method of claim 8, wherein the non-transitory computer-readable medium further comprises executable instructions that when executed by the at least one processing device causes the system to:
flag a purchase transaction associated with the electronic communication by providing, via an online banking account, an indicator of potential misappropriation proximate to information associated with the purchase transaction based at least partially on determining that one or more of the one or more rules relating to misappropriation of customer account information is satisfied.

12. The computer-implemented method of claim 8, wherein the non-transitory computer-readable medium further comprises executable instructions that when executed by the at least one processing device causes the system to:
provide a notification to the customer based at least partially on determining that one or more of the one or more rules relating to misappropriation of customer account information are satisfied.

13. The computer-implemented method of claim 8, wherein the one or more rules relating to misappropriation of customer information include a rule for comparing a listed or known customer address to a delivery address determined from the electronic communication, a rule for comparing one or more addresses previously used by a customer for receiving purchase transaction deliveries to a delivery address determined from the electronic communication, a rule for determining that a delivery address determined from the electronic communication is to a country other than a country associated with a customer associated with the electronic communication, a rule for determining that a delivery address determined from the electronic communication is to a state other than a state associated with a customer associated with the electronic communication, a rule for determining that a delivery address determined from the electronic communication is to an area associated with statistically determined high levels of misappropriation, and a rule for determining that a delivery location determined from the electronic communication is to a non-registered device and/or a device not associated with a customer associated with the electronic communication.

14. The computer-implemented method of claim 12, wherein one or more of the one or more rules relating to misappropriation of customer account information are satisfied when, at least, one of the following occurs:
a) an address and/or location information matches address and/or location information of a rule;
b) an address and/or location information does not match address and/or location information of a rule;
c) a device receiving delivery of a subject of a purchase transaction associated with the electronic communication matches a device associated with a rule; and
d) a device receiving delivery of a subject of a purchase transaction associated with the electronic communication does not match a device associated with a rule.

15. A computer program product for providing misappropriation protection based on address information or store information, the computer program product comprising a non-transitory computer-readable storage medium having computer-readable program code stored thereon, such that when the computer-readable code is executed by a computer processor it causes the computer to:
identify an electronic communication between a customer and a merchant, wherein the electronic communication is associated with a transaction between the customer and the merchant;
extract purchase transaction data from the electronic communication between the customer and the merchant, wherein purchase transaction data is product level data about the transaction between the customer and the merchant;
convert the purchase transaction data to be compatible with an online banking application;
integrate the purchase transaction data with data on the online banking application for the customer;
determine address information or merchant store information from the electronic communication; and
determine whether or not the address information or merchant store information triggers a notification or an alert to the customer based at least partially on one or more rules relating to a misappropriation of customer account information.

16. The computer program product of claim 15, wherein the address information is a shipping address or wherein the merchant store information is a store number associated with a location of the merchant.

17. The computer program product of claim 15, the non-transitory computer-readable storage medium further comprises executable instructions that when executed by the at least one processing device causes the system to:
compare portions of the address information or portions of the store information to the one or more rules relating to the misappropriation of customer account information.

18. The computer program product of claim 15, the non-transitory computer-readable storage medium further comprises executable instructions that when executed by the at least one processing device causes the system to:
flag a purchase transaction associated with the electronic communication by providing, via an online banking account, an indicator of potential misappropriation proximate to information associated with the purchase transaction based at least partially on determining that one or more of the one or more rules relating to misappropriation of customer account information is satisfied.

19. The computer program product of claim 15, the non-transitory computer-readable storage medium further comprises executable instructions that when executed by the at least one processing device causes the system to:
provide a notification to the customer based at least partially on determining that one or more of the one or more rules relating to misappropriation of customer account information are satisfied.

20. The computer program product of claim 15, wherein the one or more rules relating to misappropriation of customer information include a rule for comparing a listed or known customer address to a delivery address determined from the electronic communication, a rule for comparing one or more addresses previously used by a customer for receiving purchase transaction deliveries to a delivery address determined from the electronic communication, a rule for determining that a delivery address determined from the electronic communication is to a country other than a country associated with a customer associated with the electronic communication, a rule for determining that a delivery address determined from the electronic communication is to a state other than a state associated with a customer associated with the electronic communication, a rule for determining that a delivery address determined from the electronic communication is to an area associated with statistically determined high levels of misappropriation, and a rule for determining that a delivery location determined from the electronic communication is to a non-registered device and/or a device not associated with a customer associated with the electronic communication.
